(19) United States
(12) Patent Application Publication
(10) Pub. No.: US 2010/0275250 A1
(43) Pub. Date: Oct. 28, 2010

(54) ACCOUNT RECOVERY VIA AGING OF ACCOUNT DATA POINTS

(75) Inventors: Sabaridas Devadoss, San Jose, CA (US); Naveen Agarwal, Fremont, CA (US); Jonathan Edward Hryn, Cary, NC (US); Abhay Avachat, Pleasanton, CA (US); Arturo Bejar, Saratoga, CA (US); Shreyas Surendra Doshi, Mountain View, CA (US); Henry Arshell Watts, Sunnyvale, CA (US)

Correspondence Address: Yahoo! Inc.;c/o Frommer Lawrence & Haug LLP, 745 Fifth Avenue, NEW YORK, NY, 10151, US

(73) Assignee: Yahoo! Inc., Sunnyvale, CA (US)

(21) Appl. No.: 12/429,507

(22) Filed: Apr. 24, 2009

(51) Int. Cl. H04L 9/32; G06F 21/00

(52) U.S. Cl. 726/6

(57) ABSTRACT

Embodiments are directed towards providing an aging of account data points usable in recovering access to an account. The aging functionality of account data points is configured to enable users who may have had access to their account compromised or otherwise denied, still be able to recover access. Account data points are time stamped when associated with an account. When a request is received to delete the account data point, the account data point is instead placed into an aging status for a time period. During the aging status time period, the account data point may still be used to recover access to the account. Moreover, after access is recovered using a certain account data point, any account data points created after the certain account data point may be deleted to minimize unauthorized access to the account.

### TECHNICAL FIELD

The embodiments relate generally to user account management and, more particularly, but not exclusively to enabling account recovery using aging of account data points used to authenticate a user.

### BACKGROUND

There may be any of a variety of reasons that a legitimate owner of a network account may be unable to access their own network accounts. For example, the owner may have forgotten their password. In such situations, traditional account recovery mechanisms are configured for the owner to provide some form of identification. The identification might be, for example, access to an email address that is linked to the network account, a birth date, or perhaps an answer to a question for which the owner is expected to know. If the account recovery mechanism determines that the provided identification is tied to the network account, the account recovery mechanism may provide the legitimate owner access to the network account.

Such approaches, however, have increasingly come under attack. For example, an owner of a network account might receive an email message, or other type of message, that may direct the owner to a phishing website. Alternatively, the owner might inadvertently enter an incorrect web page network address that directs the owner to the phishing website. There are many other ways, beyond these, in which the owner might end up at a phishing website. In any event, once at the phishing website, the owner might be lulled into providing their login information to their network account. Once this information is provided to a hacker or other unauthorized party, the information may then be improperly used to access the owner's network account. The hacker, or other unauthorized party, may then change the email address, password, question/answer combination, birth date, or other identification information, thereby making it virtually impossible for the owner to then access his or her own network account. Thus, it is with respect to these considerations and others that the present invention has been made.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding, reference will be made to the following Detailed Description, which is to be read in association with the accompanying drawings, wherein:

FIG. 1 is a system diagram of one embodiment of an environment in which embodiments of the invention may be practiced;

FIG. 2 shows one embodiment of a client device that may be included in a system implementing various embodiments;

FIG. 3 shows one embodiment of a network device that may be included in a system implementing various embodiments;

FIG. 4 illustrates a logical flow diagram generally showing one embodiment of a process for managing network account recovery using data point aging;

FIG. 5 illustrates a logical flow diagram generally showing one embodiment of a process for determining whether a data point is valid for account recovery based, in part, on aging;

FIG. 6 illustrates one embodiment of a non-limiting example of an account recovery timeline and notifications timeline for data points with aging; and

FIG. 7 illustrates one embodiment of a non-limiting, non-exhaustive example of account management using data point aging, usable in discussing various possible use case scenarios.

### DETAILED DESCRIPTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The following briefly describes the embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, embodiments are directed towards providing an aging of account data points usable in recovering access to an account. The aging functionality of account data points is configured to enable users who may have had access to their account compromised or otherwise denied, still be able to recover access to the account.

As used herein, the term “account data points” refers to those keys, identifiers, or other forms of information used to authenticate a user during an account recovery process, such as where access to the account may have been denied. Account data points may include any of a variety of information, including, but not limited to a messaging address, a date of birth, a mobile device identifier, a unique item of information about a user or expected to be known only by the user, a postal code, or even a question/answer combination. Account data points differ from the information used to perform authentication during a login process to the account in at least their function—to enable account access recovery, as opposed to performing login authentication. As used herein, the term “account” refers to any computing accessing structure with which one or more users are associated. Accounts include but not limited to messaging accounts, Internet Service Provider (ISP) accounts, social networking accounts, or other type of computer access account structures.

An account owner may provide one or more account data points for use in account access recovery. In one embodiment, the account owner may be presented with a web page, or other interface mechanism useable to view, and/or modify one or more account data points for the account. Account data points are time stamped when associated with an account. In one embodiment, when a user provides an account data point, the account data point is initially placed into an inactive status for some defined time period, during which the account data point is ineligible for use in recovering access to the account. However, after expiration of the time period, the account data point transitions automatically to an active status, whereby the account data point becomes eligible for use in account access recovery. In another embodiment, at least some of the account data points may be made immediately active, and not be placed into an inactive status.

If a request is received to delete an active account data point, the account data point is instead transitioned to an aging status for another time period, during which the aging account data point remains available for use in recovering access to the account. In one embodiment, inactive account data points may be deleted, rather than transitioned to the aging status. In one embodiment, the account data point that is in the aging status may not be visible to a user on an account data point web page, or the like. In that manner, an unauthorized individual may be unaware that the aging account data point is still available for use.

Moreover, during each change in account activity that affects passwords, account names, account data points, or the like, an account notification is sent to each of the identifiable messaging account data points. In one embodiment, when a user attempts to log into their account, a message may be provided to the user indicating that one or more account data points have been modified.

In one non-limiting, non-exhaustive scenario, a user may have generated an account for use in any of a variety of computer-based activities. In one embodiment, the user associates a first account data point with the account for use in recovering access to their account. Consider, in this scenario, that the user gets phished into providing their username/password information to a hacker for the account. The hacker may then log into the user's account and change the first account data point that the user provided. For example, the hacker might change the user's first account data point from one email address to another email address. Moreover, the hacker may also change the password that enables the user to access their own account. When the user attempts to login, the user may be unable to login, because the password was changed. With account data point aging, the user may still be able to recover access to their account by using their first account data point, even though the hacker had replaced it with their own. Moreover, the user may now remove any subsequent account data point (and password) which the hacker may have entered thereby minimizing the likelihood that the hacker will be able to gain access to the user's account.

### Illustrative Operating Environment

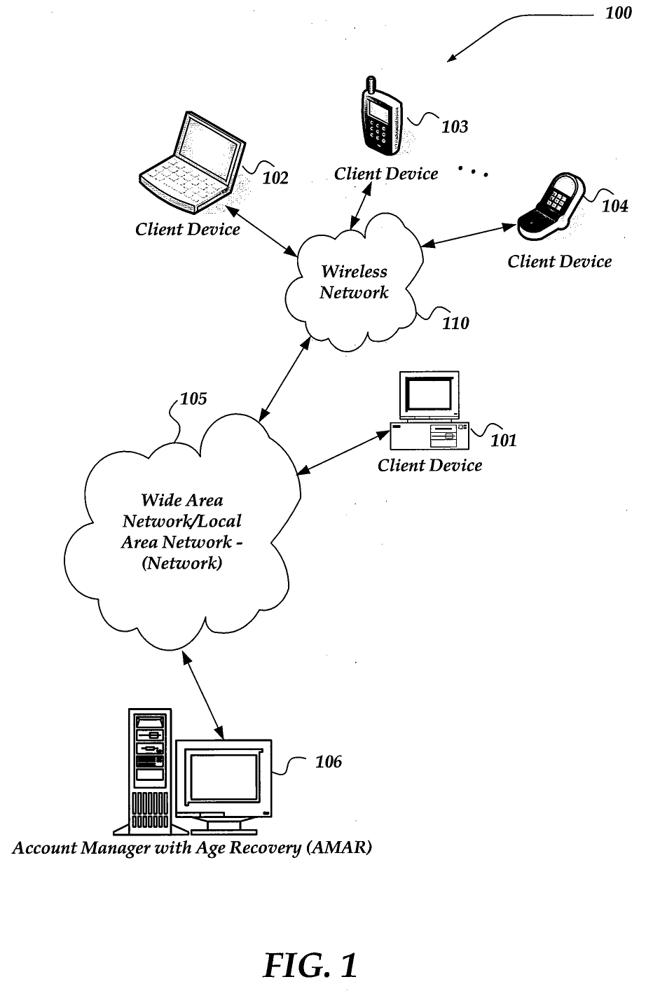

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)—(network) 105, wireless network 110, client devices 101-104, and Account Manager with Age Recovery (AMAR) 106.

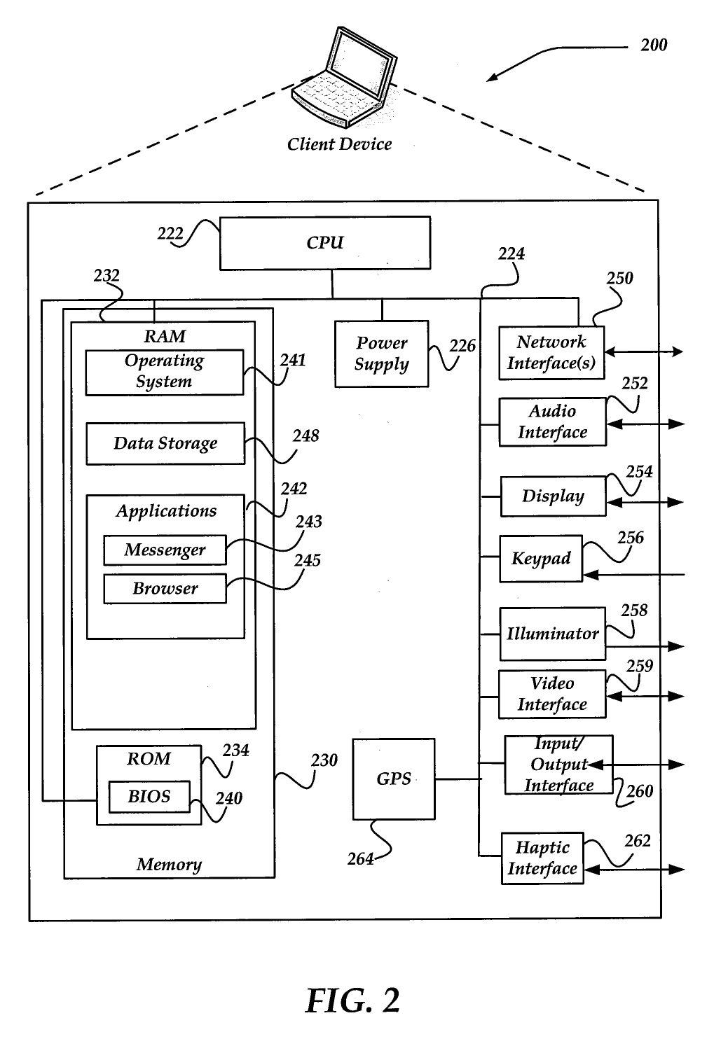

One embodiment of a client device usable as one of client devices 101-104 is described in more detail below in conjunction with FIG. 2. Generally, however, client devices 102-104 may include virtually any mobile computing device capable of receiving and sending a message over a network, such as wireless network 110, or the like. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, or the like. Client device 101 may include virtually any computing device that typically connects using a wired communications medium such as personal computers, multiprocessor systems, microprocessor-based or programmable consumer electronics, network PCs, or the like. In one embodiment, one or more of client devices 101-104 may also be configured to operate over a wired and/or a wireless network.

Client devices 101-104 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphics may be displayed.

A web-enabled client device may include a browser application that is configured to receive and to send web pages, web-based messages, or the like. The browser application may be configured to receive and display graphics, text, multimedia, or the like, employing virtually any web-based language, including a wireless application protocol messages (WAP), or the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client devices 101-104 also may include at least one other client application that is configured to receive content from another computing device. The client application may include a capability to provide and receive textual content, multimedia information, or the like. The client application may further provide information that identifies itself, including a type, capability, name, or the like. In one embodiment, client devices 101-104 may uniquely identify themselves through any of a variety of mechanisms, including a phone number, Mobile Identification Number (MIN), an electronic serial number (ESN), mobile device identifier, network address, or other identifier. The identifier may be provided in a message, or the like, sent to another computing device.

Client devices 101-104 may also be configured to communicate a message, such as through email, SMS, MMS, IM, IRC, mIRC, Jabber, or the like, between another computing device. However, the present invention is not limited to these message protocols, and virtually any other message protocol may be employed.

Client devices 101-104 may further be configured to include a client application that enables the user to log into a user account that may be managed by another computing device, such as AMAR 106, or the like. Such user account, for example, may be configured to enable the user to receive emails, send/receive IM messages, SMS messages, access selected web pages, or participate in any of a variety of other social networking activity. However, managing of messages or otherwise participating in other social activities may also be performed without logging into the user account.

In one embodiment, the user of client devices 101-104 may also be enabled to access a web page, or other user interface that enables the user to enter, select, and/or otherwise generate one or more account data points useable to enable access recovery to an account. Such access recovery might arise, for example, should the user be denied access to the account for entering an improper password, digital certificate, s/key, passcode, or other login credential. In one embodiment, the entry may be improper for a variety of reasons, including, but not limited to the user having forgotten the login credential, mistyped the login credential, or even where the login credential may have been changed by another user, such as a hacker, or the like.

Wireless network 110 is configured to couple client devices 102-104 with network 105. Wireless network 110 may include any of a variety of wireless sub-networks that may further overlay stand-alone ad-hoc networks, or the like, to provide an infrastructure-oriented connection for client devices 102-104. Such sub-networks may include mesh networks, Wireless LAN (WLAN) networks, cellular networks, or the like.

Wireless network 110 may further include an autonomous system of terminals, gateways, routers, or the like connected by wireless radio links, or the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G), 4th (4G) generation radio access for cellular systems, WLAN, Wireless Router (WR) mesh, or the like. Access technologies such as 2G, 2.5G, 3G, 4G, and future access networks may enable wide area coverage for client devices, such as client devices 102-104 with various degrees of mobility. For example, wireless network 111 may enable a radio connection through a radio network access such as Global System for Mobile communication (GSM), General Packet Radio Services (GPRS), Enhanced Data GSM Environment (EDGE), Wideband Code Division Multiple Access (WCDMA), Bluetooth, or the like. In essence, wireless network 110 may include virtually any wireless communication mechanism by which information may travel between client devices 102-104 and another computing device, network, or the like.

Network 105 is configured to couple AMAR 106, and client device 101 with other computing devices, including through wireless network 110 to client devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between computing devices.

AMAR 106 represents a network-computing device that is configured to manage account recovery using aging of account (recovery) data points. In one embodiment, AMAR 106 may also manage various accounts, including, but not limited to messaging accounts, social networking accounts, and the like. However, in another embodiment, such accounts may be managed through another network device (not shown).

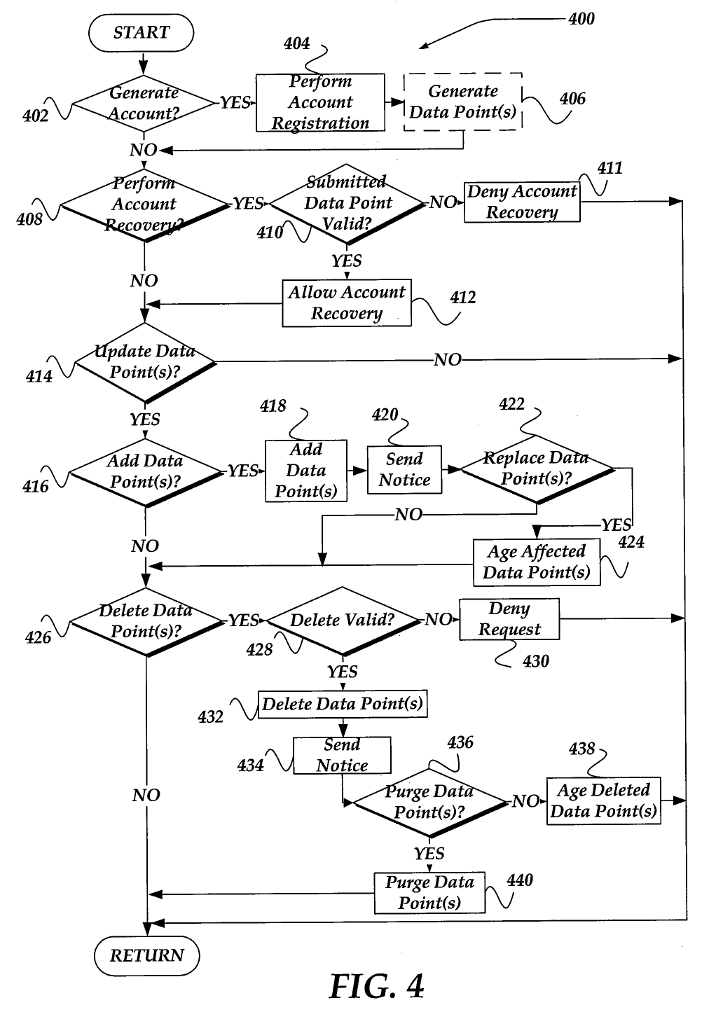

AMAR 106 may provide one or more user interfaces to client devices 101-104 for use in managing account data points, including providing account data points, deleting, and/or otherwise modifying account data points. AMAR 106 may further provide one more user interfaces for use in performing account recovery. For example, when a user attempts to log into an account, a hyperlink, or other mechanism might be displayed for use in performing account recovery. For example, in one embodiment, AMAR 106 might provide a link such as “Can't access account?” or the like. The user may then click on the link, which results in another web page displayed that might ask the user to enter an account identifier. AMAR 106 may further request the user to enter an account data point. AMAR 106 may then determine if the entered account data point is valid account recovery for the identified account. If so, AMAR 106 may then provide the user with one or more interfaces that enables the user to revise their password to the identified account, update account data points, and/or otherwise obtain access to the identified account. AMAR 106 may determine a validity of the entered account data point as described in more detail below in conjunction with FIGS. 4-7.

Devices that may operate as AMAR 106 include, but are not limited to personal computers, desktop computers, multiprocessor systems, microprocessor-based or programmable consumer electronics, network PCs, servers, network appliances, and the like.

Although AMAR 106 is illustrated as a distinct network device, the invention is not so limited. For example, a plurality of network devices may be configured to perform the operational aspects of AMAR 106. For example, in one embodiment, the accounts may be managed by one or more network devices, while account access recovery may be managed by one or more other network devices. Thus, system 100 should not be construed as limiting the invention, and other system structures may be used.

### Illustrative Client Environment

FIG. 2 shows one embodiment of client device 200 that may be included in a system implementing the invention. Client device 200 may include many more or less components than those shown in FIG. 2. However, the components shown are sufficient to disclose an illustrative embodiment for practicing the present invention. Client device 200 may represent, for example, one of client devices 101-104 of FIG. 1.

As shown in the figure, client device 200 includes a processing unit (CPU) 222 in communication with a mass memory 230 via a bus 224. Client device 200 also includes a power supply 226, one or more network interfaces 250, an audio interface 252, video interface 259, a display 254, a keypad 256, an illuminator 258, an input/output interface 260, a haptic interface 262, and an optional global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth™, infrared, Wi-Fi, Zigbee, r any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Video interface 259 is arranged to capture video images, such as a still photo, a video segment, an infrared video, or the like. For example, video interface 259 may be coupled to a digital video camera, a web-camera, or the like. Video interface 259 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. In addition, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, Wi-Fi, Zigbee, or the like. Haptic interface 262 is arranged to provide tactile feedback to a user of the client device. For example, the haptic interface may be employed to vibrate client device 200 in a particular way when another user of a computing device is calling.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances. In one embodiment, however, a client device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer readable storage media for storage of information such as computer readable instructions, data structures, program modules, or other data. Mass memory 230 stores a basic input/output system (“BIOS”) 240 for controlling low-level operation of client device 200. The mass memory also stores an operating system 241 for controlling the operation of client device 200. It will be appreciated that this component may include a general-purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 230 further includes one or more data storage 248, which can be utilized by client device 200 to store, among other things, applications 242 and/or other data. For example, data storage 248 may also be employed to store information that describes various capabilities of client device 200, as well as store an identifier. The information, including the identifier, may then be provided to another device based on any of a variety of events, including being sent as part of a header during a communication, sent upon request, or the like. In one embodiment, the identifier and/or other information about client device 200 might be provided automatically to another networked device, independent of a directed action to do so by a user of client device 200. Thus, in one embodiment, the identifier might be provided over the network transparent to the user.

Moreover, data storage 248 may also be employed to store personal information including but not limited to contact lists, personal preferences, data files, graphs, videos, or the like. Data storage 248 may further provide storage for user account information useable with one or more message accounts, social networking accounts, or the like. At least a portion of the stored information may also be stored on a disk drive or other storage medium (not shown) within client device 200. In another embodiment, however, the whitelist(s) may be stored on a remote computer, such as network device 300.

Applications 242 may include computer executable instructions which, when executed by client device 200, transmit, receive, and/or otherwise process messages (e.g., SMS, MMS, IM, email, and/or other messages), multimedia information, and enable telecommunication with another user of another client device. Other examples of application programs include calendars, browsers, email clients, IM applications, SMS applications, VOIP applications, contact managers, task managers, transcoders, database programs, word processing programs, security applications, spreadsheet programs, games, search programs, and so forth. Applications 242 may include, for example, messenger 243, and browser 245.

Browser 245 may include virtually any client application configured to receive and display graphics, text, multimedia, and the like, employing virtually any web based language. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web-based languages may also be employed.

Messenger 243 may be configured to initiate and manage a messaging session using any of a variety of messaging communications including, but not limited to email, Short Message Service (SMS), Instant Message (IM), Multimedia Message Service (MMS), internet relay chat (IRC), mIRC, and the like. For example, in one embodiment, messenger 243 may be configured as an IM application, such as AOL Instant Messenger, Yahoo! Messenger, .NET Messenger Server, ICQ, or the like. In one embodiment messenger 243 may be configured to include a mail user agent (MUA) such as Elm, Pine, MH, Outlook, Eudora, Mac Mail, Mozilla Thunderbird, gmail, or the like. In another embodiment, messenger 243 may be a client application that is configured to integrate and employ a variety of messaging protocols. In one embodiment, messenger 243 may employ various message boxes or folders to manage and/or store messages.

### Illustrative Network Device Environment

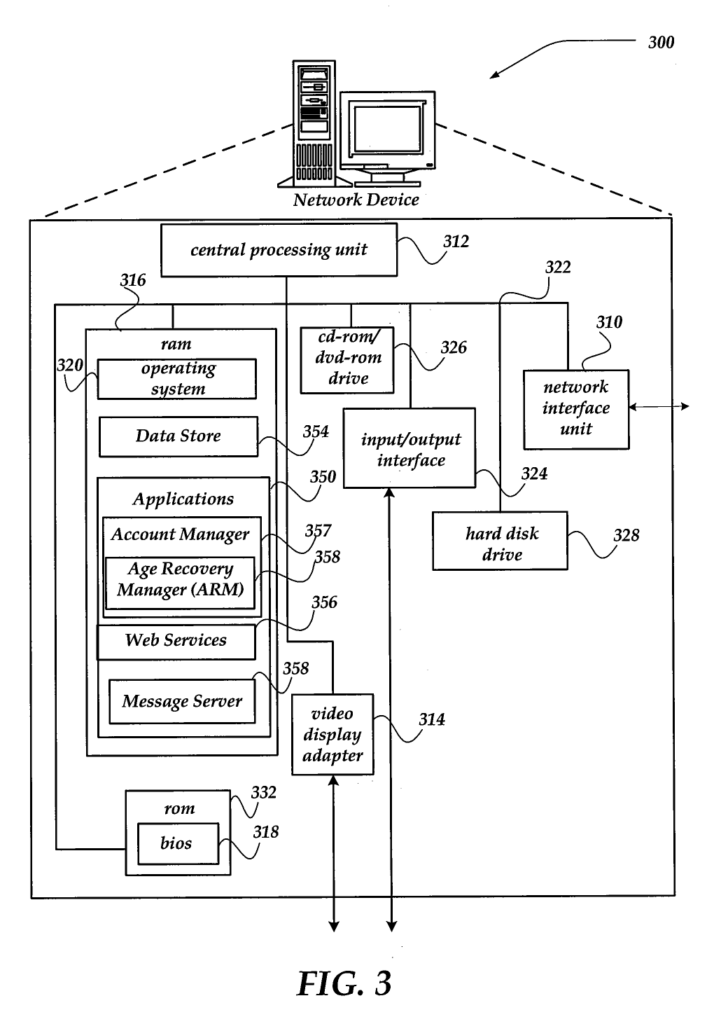

FIG. 3 shows one embodiment of a network device, according to one embodiment of the invention. Network device 300 may include many more components than those shown. The components shown, however, are sufficient to disclose an illustrative embodiment for practicing the invention. Network device 300 may represent, for example, AMAR 106 of FIG. 1.

Network device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer-readable media, namely computer storage media. Computer-readable storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other physical medium which can be used to store the desired information and which can be accessed by a computing device.

The mass memory also stores program code and data. For example, mass memory might include data store 354. Data store 354 may be include virtually any mechanism usable for store and managing data, including but not limited to a file, a folder, a document, or an application, such as a database, spreadsheet, or the like. Data store 354 may manage information that might include, but is not limited to web pages, accounts, account access information, account (recovery) data points, or the like, as well as scripts, applications, applets, and the like.

One or more applications 350 may be loaded into mass memory and run on operating system 320. Examples of application programs may include transcoders, schedulers, calendars, database programs, word processing programs, HTTP programs, customizable user interface programs, IPSec applications, encryption programs, security programs, VPN programs, web servers, account management, and so forth. Applications 350 may include web services 356, Message Server (MS) 358, and account manager 357. Account manager 357 may also include Age Recovery Manager (ARM) 358. However, in another embodiment, ARM 358 may be distinct from account manager 357, including operating on a different network device that may be substantially similar to network device 300.

Web services 356 represent any of a variety of services that are configured to provide content, including messages, over a network to another computing device. Thus, web services 356 include for example, a web server, messaging server, a File Transfer Protocol (FTP) server, a database server, a content server, or the like. Web services 356 may provide the content including messages over the network using any of a variety of formats, including, but not limited to WAP, HDML, WML, SMGL, HTML, XML, cHTML, xHTML, or the like.

Message server 358 may include virtually any computing component or components configured and arranged to forward messages from message user agents, and/or other message servers, or to deliver messages to a local message store, such as data store 354, or the like. Thus, message server 358 may include a message transfer manager to communicate a message employing any of a variety of email protocols, including, but not limited, to Simple Mail Transfer Protocol (SMTP), Post Office Protocol (POP), Internet Message Access Protocol (IMAP), NNTP, or the like.

However, message server 358 is not constrained to email messages, and other messaging protocols may be managed by one or more components of message server 358. Thus, message server 358 may also be configured to manage SMS messages, IM, MMS, IRC, mIRC, or any of a variety of other message types.

Account manager 357 is configured to manage access to user accounts. As such, account manager 357 may perform a variety of account management functions, including, but not limited to user authentication, authorization, accounting, security, and/or resource management activities. In one embodiment, account manager 357 may also provide access to resources associated with an account, including, for example, messaging, web pages, data, documents, or the like.

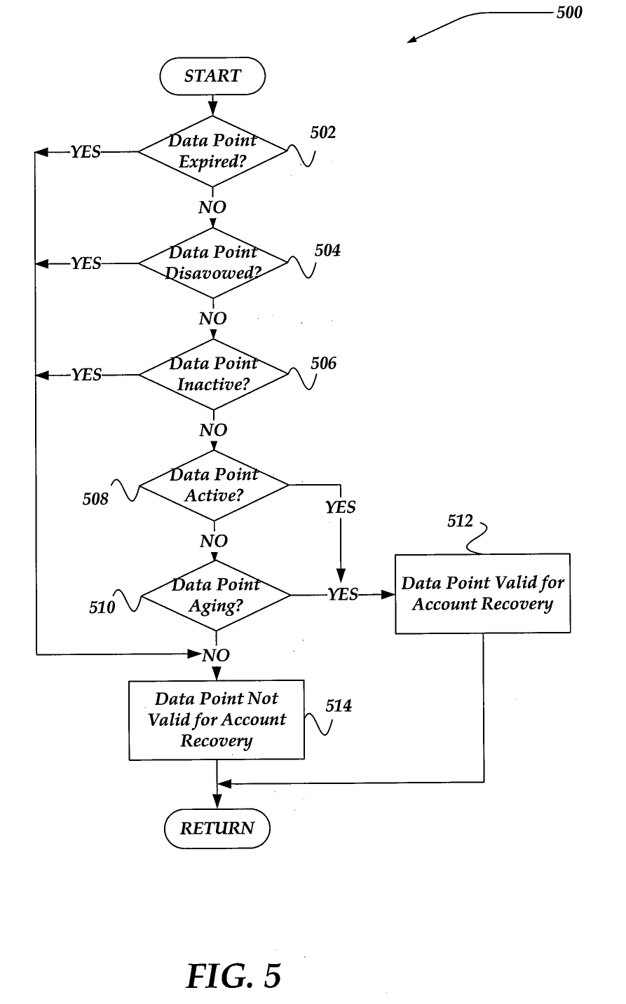

ARM 358 is configured to manage account access recovery. ARM 358 may provide one or more user interfaces useable to enable a user to manage account (recovery) data points, and to employ the account data points for recovering access to an account. ARM 358 may employ processes such as those described in more detail below in conjunction with FIGS. 4-5 to perform at least some of its actions.

### Generalized Operation

The operation of certain aspects of the invention will now be described with respect to FIGS. 4-7. FIG. 4 illustrates a logical flow diagram generally showing one embodiment of a process for managing network account recovery using data point aging. Process 400 of FIG. 4 may be implemented within AMAR 106 of FIG. 1, in one embodiment.

Process 400 begins, after a start block, at decision block 402, where a determination is made whether to generate an account. As noted elsewhere, an account may be employed to access any of a variety of information, and/or provide any of a variety of services. For example, an account might be associated with a messaging service, a merchant service, or the like. In any event, if a request is received, processing flows to block 404; otherwise, processing continues to decision block 408.

At block 404, a user may provide information useable for generating an account. Such information may be part of an account registration process, whereby the user might enter or otherwise receive an account identifier, provide a password, credential, or even receive a credential useable to log into the account. In one embodiment, the user might enter other information, such as credit card information, address information, personal information, or the like. Such information may vary from account to account.

Processing may then flow to an optional block 406, where the user may be presented with an interface useable to enter or otherwise generate one or more account (recovery) data points. In one embodiment, such generation may result in such account data points being captured by a server, such as AMARS 106 of FIG. 1. In yet another embodiment, at least some account data points may be generated by the server. For example, one account data point generated by the server might include a date on which an account is generated. Another account data point might include an identifier of another person's buddy list, address book, or the like, on which the user of the account may be listed. Thus, as used herein, generating one or more account data points, includes, receiving user provided account data points, generating account data points by the server, and/or otherwise capturing account data points from any of a variety of sources. It is important to note, that while the user may provide one or more account data points at this juncture, the user may also select not to enter any account data points, and bypass this activity. However, typically, a user may provide such information. In any event, if the user enters one or more account data points, they are time stamped, and could be, depending on system policies, placed into an inactive status for some defined time period. While an account data point is identified as inactive, the account data point may not be eligible for account recovery. In this manner, protection may be provided for situations, such as a hacker providing an account data point, and later the authorized owner of the account removing the hacker's account data point. In such situations, the hacker will be unable to use their improper account data points to again gain access to the account. In one embodiment, the defined time period for an account data point remaining in inactive status may range from between about 10 days to about 45 days. However, the invention is not constrained to these time periods, and others may be selected based on historical studies of time periods, statistical analysis of recovery events, engineering judgment, policy, or the like. After an account data point has remained in inactive status for the defined time period (and it has not been deleted), the account data point automatically transitions to an active status. In the active status, the account data point may then be employed to recover access to the account. In any event, processing flows next to decision block 408.

At decision block 408, a determination is made whether a request is received to perform account access recovery. If so, processing flows to decision block 410; otherwise, processing continues to decision block 414.

At decision block 414, an interface may be provided to a user, where the user may submit an account (recover) data point. In one embodiment, the user may also provide an account identifier. A determination is then made to determine whether the submitted account data point is valid for the provided account identifier. One embodiment of a process useable to make such determinations is described below in conjunction with FIG. 5. Briefly, however, an account data point may be valid if it is an active account data point associated with the account, or is in an aging status for the identified account. If the submitted account data point is determined to be valid for the identified account, processing flows to block 412; otherwise, processing flows to block 411. At block 411, access to the identified account is denied. In one embodiment, processing may return to a calling process to perform other processes. In another embodiment, a user may be provided a defined number of attempts to provide a valid account data point within a defined amount of time. If unsuccessful, the user may be referred to a live communications with a help desk, or the like. At block 412, however, if the account data point is valid, access to the account may be provided. In one embodiment, access may allow the user to provide a new password to the account. Moreover, the user may be provided one or more user interfaces, such as a web page, or the like, to update their account data points. Thus, as illustrated in FIG. 4, processing may flow to decision block 414.

At decision block 414, a determination is made whether a request is received to update one or more account data points. If such a request is received, processing flows to decision block 416; otherwise, processing may return to a calling process to perform other actions.

At decision block 416, a determination is made whether a request is received to add an account data point. If a request is received to add, then processing flows to block 418; otherwise, processing flows to decision block 426.

At block 418, one or more account data points are received from the user. Processing flows to block 420, next, where a notice is sent indicating that account data points have been added, or otherwise, modified. In one embodiment, the notice is sent to each messaging address that may be associated with the account. For example, by default, an account may have a messaging address. However, one or more of the account data points may be a messaging address, a mobile device identifier, or the like. As such, the notice may be sent to each of the identifiable addresses, phone numbers, or the like. Processing next flows to decision block 422, where a determination is made whether the added account data point replaces another pre-existing account data point. In one embodiment, account data points may be definable based on a data point type. For example, one data point type might be a question/answer combination type. Another data point type might be a mobile device identifier, while still another data point type might be a messaging address type, or a birth date type, or a postal code type, or the like. In one embodiment, some data point types may be exclusive, in the sense that only one account data point may be used within that type at a time. Thus, an addition of an account data point in that type automatically results in a replacement activity, where the prior account data point is to be deleted or otherwise replaced by the new account data point. Examples of such single data point types might include birth dates, question/answer combinations, or the like. Other data point types may be inclusive, in the sense that an addition of an account data point does not replace necessarily a prior account data point. For example, in one embodiment, mobile device identifiers, messaging addresses, or the like, might be definable as inclusive. That is, a user might enter more than one mobile device identifier. It is important to note, however, that such type definitions, and/or constraints upon data types may be implementation specific.

In any event, if at decision block 422, if a replacement of a data point is to be performed, processing flows to block 424; otherwise, processing flows to decision block 426. At block 424, if the account data point to be replaced is currently in active status, then the account data point is transitioned to aging status (i.e., having the status of aging), where the account data point may remain for a defined time period. Upon expiration of the defined time period, the account data point may be deleted, such that it is no longer available for use in account data recovery. Moreover, if an account data point is currently identified in aging status, and is further identified as an exclusive type for which the additional account data point may affect, then in one embodiment, a timer associated with a time period for which the account data point retains aging status might be reset. In one embodiment, an aging status time period may be set to virtually any value. For example, in one embodiment, aging status time periods might be set based on data type. In another embodiment, aging status time periods may be set from between about 10 days to about 90 days.

Processing then flows to block decision block 426. At decision block 426, a determination is made whether a request is received to delete an account data point. If so, then processing flows to decision block 428; otherwise, processing may return to a calling process to perform other actions.

At decision block 428, a determination is made whether the request to delete is a valid request. In one embodiment, validity may be based on a relationship in time of the account data point to be deleted with respect to an account data point employed to recover access, at decision block 410. For example, in one embodiment, an account data point generated earlier in time may be used to delete account data points generated later in time such that the deleted account data point is no longer available to recover access to the account. However, account data points generated earlier in time to the account data point used to recover account access, might be instead placed into an aging status, and therefore may be available for account access recovery. Thus, at decision block 428, a relationship determination may be made, in one embodiment. If the request to delete the account data point is determined to be valid, processing flows to block 432; otherwise, processing flows to block 430. At block 430, the request may be denied. In one embodiment, such denial may be made through a notice, or the like. In any event, processing then returns to a calling process to perform other actions.

At block 432, the account data point is deleted. Processing flows next to block 434, where a notice is sent to one or more messaging addresses, mobile device identifiers, or the like, indicating that a modification is made to the account data points. Processing then flows to decision block 436, where a further determination is made whether the deleted account data point is to be purged such that it is unavailable for account recovery (flowing to block 440); or whether the deleted account data point is to transition to aging status, where it may be available for a defined time period for account recovery (block 438). In either event, processing then returns to a calling process to perform other actions.

FIG. 5 illustrates a logical flow diagram generally showing one embodiment of a process for determining whether a data point is valid for account recovery based, in part, on aging. Process 500 may represent, in one embodiment, a process usable at decision block 410 of FIG. 4. However, other mechanisms may also be used. For example, in one embodiment, different, albeit similar, processes may be used based on a data point type.

In any event, process 500 begins, after a start block, at decision block 502, where a determination is made whether the account data point is expired. An account data point may be considered to have expired, if it is deleted or purged and is no longer in an aging status. If the account data point is expired, processing flows to block 514; otherwise, processing flows to decision block 504.

At decision block 504, a determination is made whether the account data point is disavowed. An account data point may be considered to be disavowed where, for example, where an account owner added another user's messaging address, mobile device identifier, phone number, or the like, to the current account as an account data point, and the other user has refused usage of such identifier by the account owner. If the account data point is disavowed, processing flows to block 514; otherwise, processing flows to decision block 506.

At decision block 506, a determination is made whether the account data point is inactive. As noted above, an account data point may be considered inactive for a defined time period after which it has been generated, selected, or otherwise provided for use for the account, and the time since such action has not been exceeded. Thus, if the account data point is inactive, processing flows to block 514; otherwise, processing flows to decision block 508.

At decision block 508, a determination is made whether the account data point is considered to be active (its status is active). If so, then processing flows to block 512; otherwise, processing flows to processing flows to decision block 510.

At decision block 510, a determination is made whether the account data point has a status of aging, or deactivated. If so, then processing flows to block 512; otherwise, processing flows to block 514.

At block 512, the account data point may be marked or otherwise identified as being eligible for account access recovery. Processing then returns to a calling process. At block 514, however, the account data point is marked or otherwise identified as being ineligible for use in account access recovery. Processing then returns to a calling process.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems that perform the specified actions or steps, or combinations of special purpose hardware and computer instructions.

### Illustrative Use Case Examples

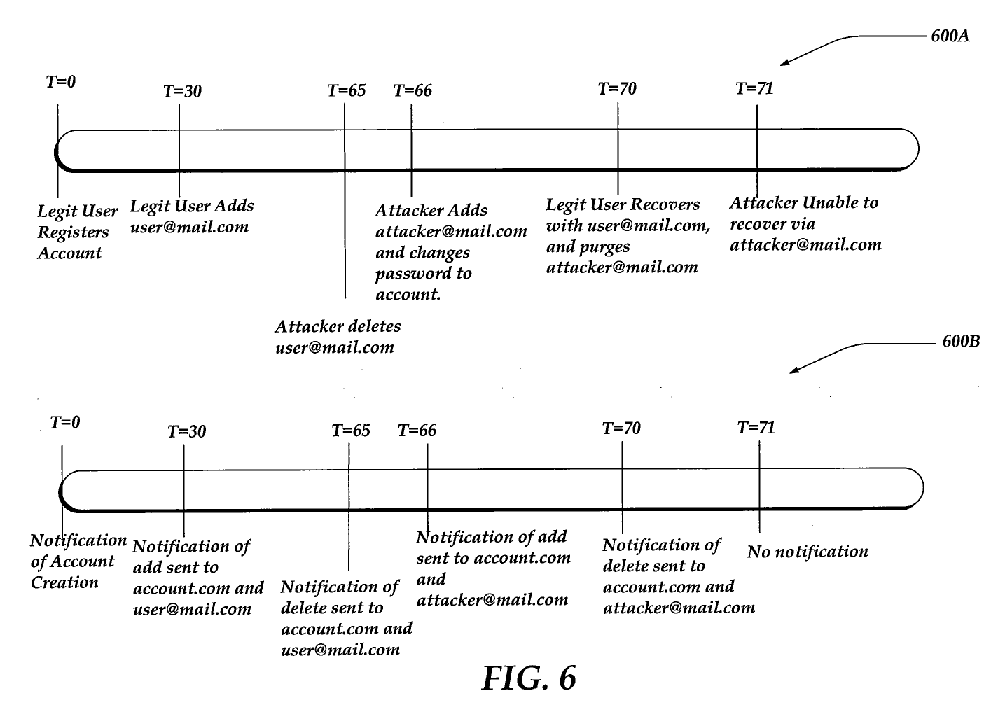

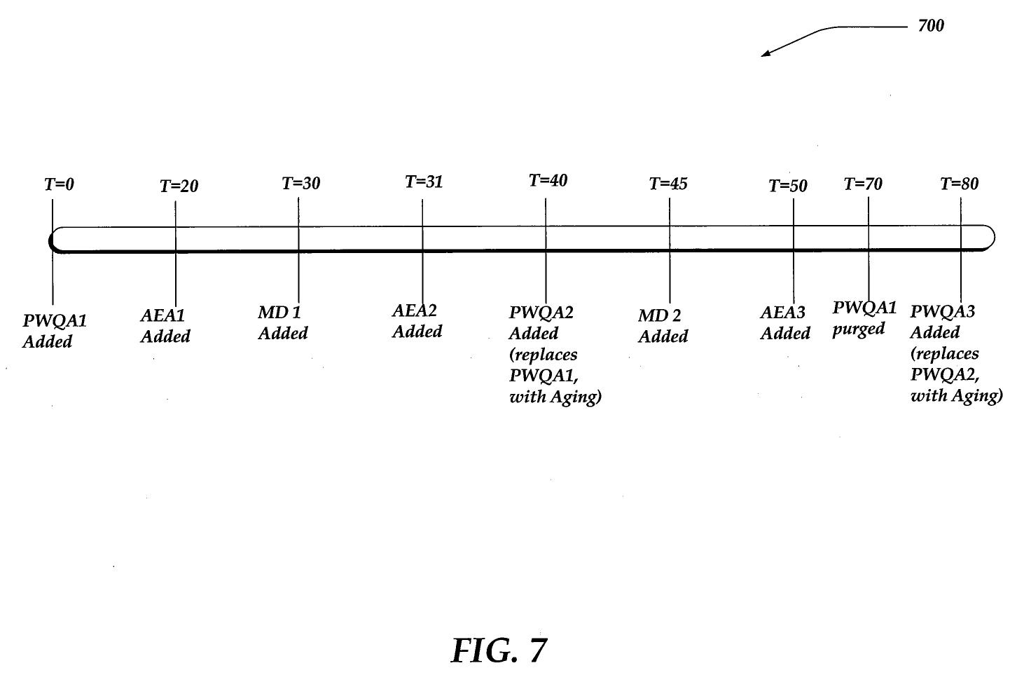

The operation of certain aspects of the invention will now be described with respect to FIGS. 6-7. FIGS. 6-7 are intended, however, to provide non-limiting, non-exhaustive illustrations of various aspects and features. For example, FIG. 6 illustrates one embodiment of a non-limiting example of an account recovery timeline and notifications timeline for data points with aging.

As shown in FIG. 6, flow 600A represents a transition of event activities that might be performed over time. Thus, “T=xx” represents an event that occurs at T=0, 30, 65, 66, 70, or 71 days. As noted, because flow 600A is intended to be merely an example use case, other times, other events may transpire. Such times, and events, therefore are not to be taken as restricting the invention. In any event, at T=0, the use case in flow 600A illustrates that Legit user registers their account. As shown, later (T=30), Legit user adds as an account data point a messaging address “user@mail.com.” Some time later (T=65) Legit user's account may be hacked, where Attacker attempts to delete the user's account data point “user@mail.com.” At this juncture, as described above, the user's account data point transitions, instead to an aging status. In one embodiment, the “deleted” aging account data point might not be displayed on a web page associated with managing account data points. Additionally, at T=66, Attacker adds a new account data point “attacker@mail.com.” In addition, the new account data point is identified in an inactive status for some time period. Moreover, Attacker may change a password to the account. At some later time (T=70), Legit user attempts to log into their account and is denied (because the password is changed). Therefore, Legit user may now employ the aging account data point to recover access to the account, and change the password. Because the attacker's account data point was generated or received in time after the user's account data point, Legit user can purge the attacker's account data point, making it unavailable for use in account recovery, when the attacker attempts to recover access to the account. In addition, even if Legit user had not purged the hacker's account data point, if the hacker's data point was still within the inactive status, it was unavailable for use in recovering access to the account.

Shown also in FIG. 6 is flow 600B, which may accompany the activities described above for flow 600A, with respect to a notifications timeline. Thus, as may be seen, when an account data point is added (T=30 and 66), a notice is sent to each messaging address, or the like, identified with the account. As shown here, for example, at T=30, this may include an account.com address associated with the account, as well as the messaging address associated with the provided account data point. Similarly, when an account data point is deleted or otherwise sought to be deleted (T=65 and 70), notices are also sent to the identified messaging addresses.

FIG. 7 illustrates one embodiment of a non-limiting, non-exhaustive example of account management using data point aging, usable in discussing various possible use case scenarios. Flow 700 may be used to illustrate usage of multiple account data points with multiple different data point types. As shown, PWQA# (where # represents a number) represents a question/answer combination. In one embodiment, PWQA account data points may be defined as exclusive, such that a new PWQA replaces a prior PWQA. AEA# (where # represents a number) represents alternate email address (AEA). In one embodiment, AEA account data points may represent inclusive data point types, where a user may have multiple simultaneous AEA account data points. Similarly, MD# represents mobile device account data points, which are also inclusive data point types, as illustrated in this non-limiting example.

Thus, as noted above, an oldest account data point may have the most privileges. That is, depending on an age of an account data point, certain privileges are provided. Privileges may include, but are not limited to: an ability to delete an account data point which places it into an aging status for a timer period, until it is expunged from the system and no longer available for use as an account recovery data point; an ability to resurrect a previously deleted (aging) account data point; and an ability to purge an account data point which expunges the account data point from being associated with the account.

As shown in flow 700, Legit user has generated an account at T=0, and has added PWQA1 as a new account data point. At this point in time, PWQA1 is in the inactive status. For purposes of illustration, assume that a time period for inactive status to be 30 days, and further assume 30 days for a time period for an aging status.

At T=20, AEA1 is added, and thus is placed into the inactive status. At T=30, Legit user adds another account data point, MD1. At T=30, PWQA1 becomes active automatically and is therefore eligible for use in account access recovery. AT T=31, AEA2 is added, and at T=40, PWQA2 is added. Because PWQA account data points are defined, in this example, to be exclusive, PWQA1 is replaced and automatically transitions to aging status. It is noted that PWQA need not be of exclusive data point type.

In any event, at T-45, MD2 is added (which, in this example, is of the inclusive data point type). At T=50 AEA3 is added. Moreover, at T=50, based on a 30 inactive time period, AEA1 transitions to the active status. At T=60 (not shown), MD1 also transitions to active status, and at T-61, AEA2 transitions to active status.

At T=70, PWAQ1 is automatically purged from association with the account for use in account recovery access. At T=80 PWQA3 is added, which replaces PWQA2, and transitions PWQA2 to aging status.

Given the above, several non-limiting user cases may be described next to help elaborate on how the invention may operate. Thus, in a first scenario, legit user may, at T=60 use AEA2 to recover access to the account. Legit user may also then purge (remove immediately) MD2 and/or AEA3. Moreover, Legit user may request account data points to be deleted, placing them into an aging status, that are the MD and AEA account data points prior to AEA2. Legit user may also have the ability to update PWQA2, thereby adding PWQA3, which places, as shown, PWQA2 into aging status.

In a second non-limiting use case scenario using flow 700, Legit user may use PWQA1 to recover access to the account on T=60. At that point in time, Legit user may also purge (remove immediately) all AEA and MD account data points. Legit user may further have PWQA1 transition to active status, and have PWQA2 be immediately purged. PWQA1 may remain on file as the active set, however, if Legit user does not add a new set of PWQA questions (PWQA3, for example). At the end of the 30 day inactive time period, PWQA1's timer may be reset to zero, if the user adds PWQA3.

In a third non-limiting use case scenario using flow 700, at T=60 Legit user may use AEA3 to recover access to the account. However, Legit user would not, in this example, be able to purge any of the account data point data. Legit user may, however, request to delete (placing the account data points into aging status) all previous MD# and AEA# account data points. Legit user, however does not have the ability to update any of the PWQA account data points.

In a fourth non-limiting use case scenario using flow 700, at T=81, Legit user may use PWQA3 to recover access to the account. At that time, Legit user may request to delete (and thereby transition them to aging status) all previous MD# and AEA# account data points. Legit user may also have the ability to add a new PWQA (PWQA4) that will rewrite or replace the current PWQA3 and thereby reset a timer to zero for PWQA2. Additionally, if Legit user does not update PWQA3, then the timer continues unabated for PWQA2 where eventually the user will only have, in this example, PWQA3 as their active account data points, after PWQA2 ages out.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A network device, comprising:
a transceiver to send and receive data over a network; and
a processor that is operative to perform actions, comprising:
generating an account data point for use in recovering access to an account;
receiving instructions to delete the account data point;
based on the instructions, selectively changing a status of the account data point to an aging status;
receiving a request to recover access to the account, wherein the request includes the account data point; and
if the account data point has the status of aging, then enabling recovery of access to the account using the account data point, and further automatically changing the status of the account data point from aging to an active status.

2. The network device of claim 1, wherein the processor is operative to perform actions, further comprising:
if the account data point has been in the aging status for a defined time period, changing the account data point to an expired status, and further deleting the account data point such that it is invalid for use in recovering access to the account.

3. The network device of claim 1, wherein changing the status of the account data point to aging status further comprises, sending a message to at least one messaging address associated with the account indicating the change in status of the account data point.

4. The network device of claim 1, wherein generating the account data point further comprising placing the account data point into an inactive status for a first time period, and then after expiration of the first time period and absent a request to delete the account data point, changing the status of the account data point to the active status.

5. The network device of claim 1, wherein selectively changing the status of the account data point further comprises:
if the account data point is in an inactive status, inhibiting use of the account data point to recover access to the account.

6. The network device of claim 1, wherein the processor is operative to perform actions, further comprising:
determining if a second account data point is generated after the account data point is generated;
if the second account data point is generated after the account data point is generated, enabling the second account data point to be purged after the account data point is employed to recover access to the account; and
if the second account data point is generated before the account data point is generated, enabling a status of the second account data point to be changed from active to aging.

7. A processor readable storage medium that includes data and instructions, wherein the execution of the instructions on a computing device enables actions, comprising:
generating an account data point to be associated with an account, the account being associated with at least one access constraint;
placing the account data point into an inactive status for a first time period, wherein the account data point is ineligible for use in recovering access to the account;
after expiration of the first time period, placing the account data point in an active status, wherein the account data point is eligible for use in recovering access to the account.
receiving instructions to delete the account data point while the account data point is in the active status;
based on the instructions, selectively changing a status of the account data point from the active status to an aging status;
receiving a request to recover access to the account, wherein the request includes the account data point; and
if the account data point has the status of aging or active, then enabling recovery of access to the account using the account data point, and further automatically changing the status of the account data point to active.

8. The processor readable storage medium of claim 7, wherein account data point is configured to be one of a messaging address, a mobile device identifier, or a question/answer combination.

9. The processor readable storage medium of claim 7, wherein the instructions enable actions, further comprising:
receiving a second account data point;
determining if the account data point is a type of account data point that is constrained to allowing a single data point for that type;
determining if the second account data point is a same type as the account data point;
if the second account data point is the same type as the account data point and the account data point is constrained to allowing a single data point, then replacing the account data point with the second account data point and:
if the status of the account data point is inactive, purging the account data point;
if the status of the account data point is aging, resetting a timer associated with aging of the account data point; and
if the status of the account data point is active, changing the status of the account data point to aging.

10. The processor readable storage medium of claim 7, wherein receiving instructions to delete the account data point further comprises receiving a request to replace the account data point with one or more other account data points.

11. The processor readable storage medium of claim 7, wherein selectively changing the status further comprises sending a notification to a messaging address or mobile device identifier associated with the account indicating that a request is received to change an account data point.

12. The processor readable storage medium of claim 7, wherein a plurality of different account data points are associated with the account, wherein at least one account data point is of a different type as another one of the account data points in the plurality, and wherein the account data points are configured to be of at least one type from the following types: a question/answer combination, a messaging address, a birth date, a postal code, a user identifier, or a mobile device identifier.

13. The processor readable storage medium of claim 7, wherein the instructions enable actions, further comprising:
receiving another instruction to delete the account data point, while the account data point is in an inactive status;
in response to the other instruction, deleting the account data point.

14. A system for enabling a communications over a network, comprising:
a client device configured to perform actions, including:
requesting generation of a network account;
providing an account data point for use in recovering access to the network account;
detecting access to the account is denied; and
sending a request to recover access to the account, wherein the request includes the account data point;
a network device configured to perform actions, including:
in response to the request, generating the network account;
receiving the account data point, placing the account data point into an inactive status for a first time period, and then upon expiration of the first time period, transitioning the status of the account data point to an active status;
receiving instructions to delete the account data point;
based on the instructions, selectively changing a status of the account data point to an aging status;
receiving the request, including the account data point, to recover access to the account; and
if the account data point has a status of aging or active, then enabling recovery of access to the account using the account data point, and further automatically changing the status of the account data point to active.

15. The system of claim 14, wherein the account data point is selected from one of the following types: a question/answer combination, a postal code, a birth date, a name, a messaging address, or a mobile device identifier.

16. The system of claim 14, wherein the access to the account is denied based on a change in at least one of a credential or a password associated with enabling access to the account.

17. The system of claim 14, wherein selectively changing the status to an aging status further comprises:
if the account data point has a status of inactive, then deleting the account data point.

18. The system of claim 14, wherein if the account data point has a status of inactive, then inhibiting recovery of access to the account using the inactive account data point.

19. The system of claim 14, wherein enabling recovery of access to the account further comprises: enabling any account data points for the account to be deleted that are received after receiving the account data point.

20. The system of claim 14, wherein the network device is configured to perform actions, further including:
receiving a request to replace the account data point with another account data point;
determining if the status of the account data point is aging, and if the status is aging, then resetting a timer associated with an aging period for the account data point;
determining if the status of the account data point is active, and if the status is active, changing the status to aging; and
determining if the status of the account data point is inactive, and if the status is inactive, deleting the account data point.
